(19) United States
(12) Patent Application Publication
(10) Pub. No.: US 2019/0127205 A1
(43) Pub. Date: May 2, 2019

(54) INFUSED BEVERAGE DISPENSER

(71) Applicants: Stephen Donaghy, Lake Oswego, OR (US); Scott Falk, University Place, WA (US)

(72) Inventors: Stephen Donaghy, Lake Oswego, OR (US); Scott Falk, University Place, WA (US)

(21) Appl. No.: 15/797,258

(22) Filed: Oct. 30, 2017

(51) Int. Cl. B67D 3/00

(52) U.S. Cl. CPC B67D 3/0096; B67D 3/0083; B67D 3/0067; B67D 3/0093

(57) ABSTRACT

A beverage dispenser is provided with a removable insert to provide aesthetically pleasing graphic representations of the current beverage type that is being provided.

### BACKGROUND

This disclosure relates to beverages, and more particularly to an esthetic and informative device and method for dispensing beverages.

Fruit-infused, vegetable-infused, herb-infused, spice-infused or other flavor-infused water provides a refreshing beverage that is enjoyed by many. Historically, infused water can only be provided by adding pieces of cut-up fruit, vegetables or other flavoring component and dropping them into a container or vessel full of water. If the container is clear or nearly so, the consumer is able to see the actual fruit inside the vessel before tasting the contents, assisting in identifying what flavor the water might have and providing an aesthetically appealing presentation.

Many organizations desire to serve fruit-infused water to their employees or customers, to provide a more pleasant work or customer experience. However, heretofore this required a chef or food worker to cut up the fruit and prepare batches of infused water for serving. Also, with fruit, vegetable and other perishable flavoring components, maintaining cold storage and monitoring the product for freshness becomes an issue, requiring expense and personnel who are trained or certified in food handling.

### SUMMARY

In accordance with the disclosure, an infused beverage dispenser provides a low cost, efficient way for an owner to provide fruit-infused, vegetable-infused or other flavor-infused water to a user not by using cut-up fruit, vegetable or other flavorings, but with shelf-stable extracted oils of a fruit, vegetable or other shelf-stable concentrates that can be mixed with the water in the vessel. The vessel uses a slot defined between the walls of a two-piece tower to provide an appealing graphic display of the contents of the infused water or other beverage.

The dispenser is comprised of three components, all separate but part of a whole that work together to affect the intended result. The first component is the clear inner tower which holds the liquid (infused water, for example) and a faucet. This component acts as the water container or vessel that provides the liquid to be dispensed to users. This component has laser etched markings to indicate contents level, and it also has an indexing lip at its base that is responsible for holding up the graphic which is displayed on the outside of this vessel and aligning the outer tower.

The clear outer tower (second component) fits seamlessly over the inner tower and holds in the graphic panel that visually displays the contents of the inner vessel.

The third component is a unique two layer lid that works to: #1 cover the liquid contents of the inner vessel; #2 fit snuggly over the graphics and outer tower; #3 allow air flow to the inner container so that water can be dispensed evenly and without interruption.

The subject matter of the present technology is particularly pointed out and distinctly claimed in the concluding portion of this specification. However, both the organization and method of operation, together with further advantages and embodiments thereof, may best be understood by reference to the following description taken in connection with accompanying drawings wherein like reference characters refer to like elements.

### BRIEF DESCRIPTION OF THE DRAWINGS

FIG. 1 is a perspective view of an infused beverage dispenser;

FIG. 2 is an exploded view of the infused beverage dispenser illustrating construction thereof;

FIG. 3 is front view of the infused beverage dispenser of FIG. 1 with the components partially separated;

FIG. 4 is a sectional view of the beverage dispenser, taken along line 3-3 of FIG. 3;

FIG. 5 is a top view of the infused beverage dispenser with the lid off;

FIGS. 6 and 7 are perspective views of the infused beverage dispenser illustrating insertion/removal of the graphic display;

FIGS. 8-11 are views of exemplary graphic inserts for a variety of infusion flavors; and

FIG. 12 is a rear view of the inner container of the infused beverage dispenser.

### DETAILED DESCRIPTION

The system according to a preferred embodiment of the present disclosure comprises a beverage storage vessel with and replaceable graphic element to inform consumers of the infusion flavor currently being dispensed.

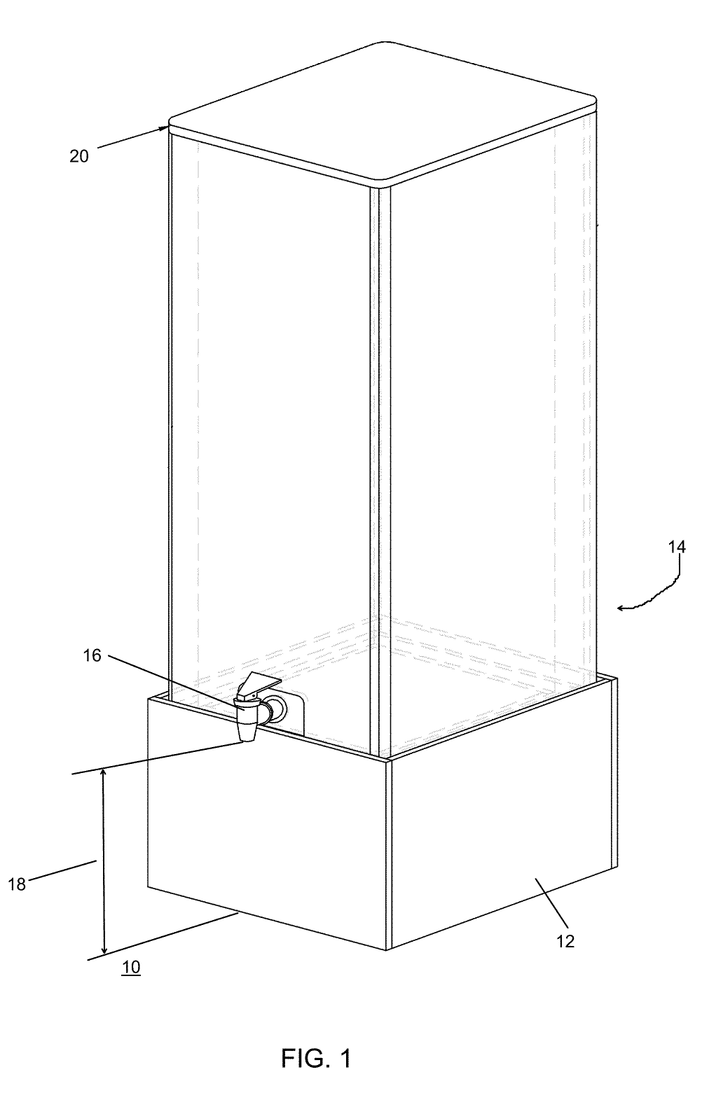

Referring to FIG. 1, a perspective view of an infused beverage dispenser, the dispenser system 10 comprises a base 12 that supports the beverage container portion 14 thereon, to maintain a height above the surface on which the beverage dispenser is sitting for bottom of the dispenser faucet 16 to have vertical clearance 18 from the surface to allow a cup or container to be positioned under the mouth of the faucet for dispensing liquid into the cup/container. A removable lid 20 fits on top of the container portion to allow access for adding product to the container portion while providing cover to maintain the sanitary condition of the beverage in the container portion.

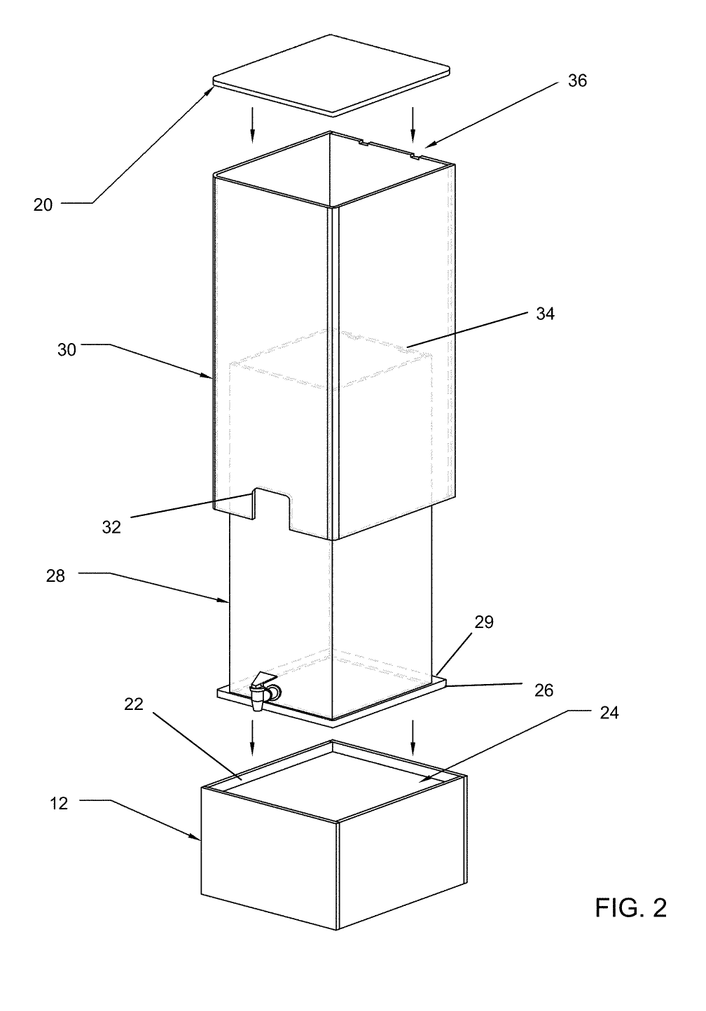

Referring now to FIG. 2, an exploded view of the infused beverage dispenser, the base 12 has an upper elevated edge portion 22 and a slightly recessed floor 24, while the liquid container portion 28 has a base 26 which is sized to fit within the interior of the edge portion 22, resting on floor 24. Base portion 26 defines the bottom of liquid container 28, suitably having sealed edges so that any liquid inside container 28 does not leak out. Base portion 26 extends beyond the peripheral edges of container 28, defining an indexing lip 29. The dispenser faucet 16 is positioned near the bottom of the container 28 and allows liquid inside container 28 to be dispensed by operation of the dispenser faucet. In the illustrated embodiment, the dispenser faucet is a lever operated style, but other faucets can be employed with a variety of dispensing operation modes, such as push button, rotary faucet style, etc. In the illustrated embodiment, the container 28 is rectangular in horizontal cross section, but any configuration can be employed, such as cylindrical or interesting geometric shaped containers.

An outer wall member 30 of corresponding shape to that of container 28, but having inner dimensions slightly larger than the outer dimensions of container 28, is positioned about the container 28. Base portion 26 extends horizontally outward farther than the outer periphery of the container 28. The gap between 26 and 28, providing a space receiving member 30 and the bottom edges of member 30 rest against the base 12 when fully lowered over container 28. Member 30 has a cut out portion 32 designed to accommodate the faucet 16 where it extends out of container 28 so that the member can be fully lowered around container 28. When member 30 is positioned about container 28, a small gap 42 is defined between the outer periphery of container 28 and the inner periphery of member 30. An exemplary size of the gap is ¼ inch, for example.

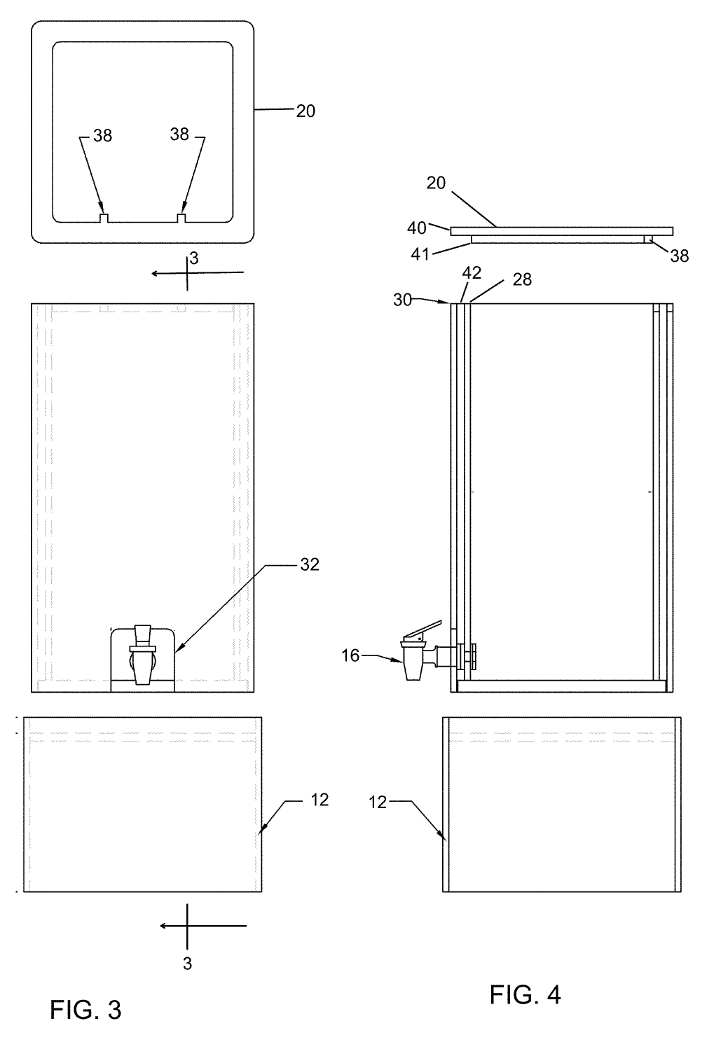

At the upper rear portion of container 28, one or more vent notches 34 are defined, with correspondingly positioned notches 36 provided in member 30 and notches 38 provided in the underside of lid 20, visible in FIG. 3.

Referring now to FIG. 3, a front view of the infused beverage dispenser of FIG. 1 with the components partially separated, and FIG. 4, a sectional view of the beverage dispenser, taken along line 3-3 of FIG. 3, the lid 20 is illustrated flipped up in FIG. 3 so the bottom portion thereof is visible. Vents 38, two being provided in the illustrated embodiment, align with the corresponding vents 34 and 36 when the beverage dispenser is assembled. Lid 20 has a wider upper portion 40 and a smaller dimension inner bottom portion 41 such that the inner bottom portion fits within the upper opening of container 28, while the upper portion 40 fits over and covers the entire open top of member 30.

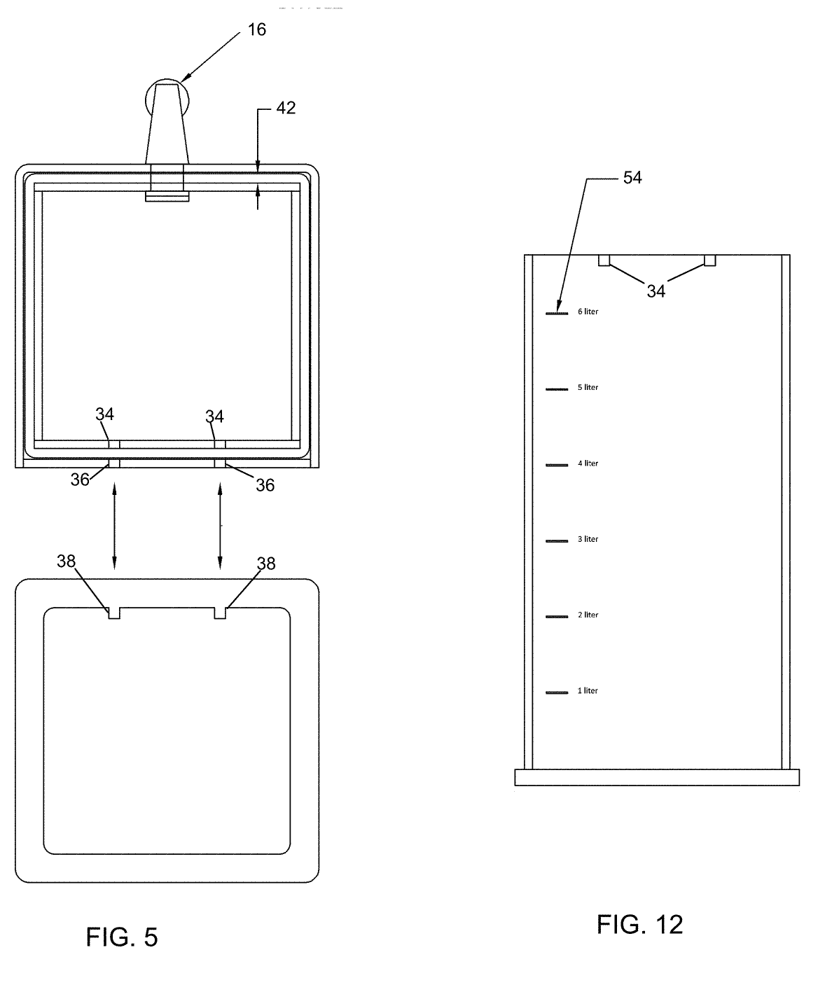

FIG. 5, a top view of the infused beverage dispenser with the lid off and flipped rearwardly, illustrates the alignment of the air vents 34, 36 and 38.

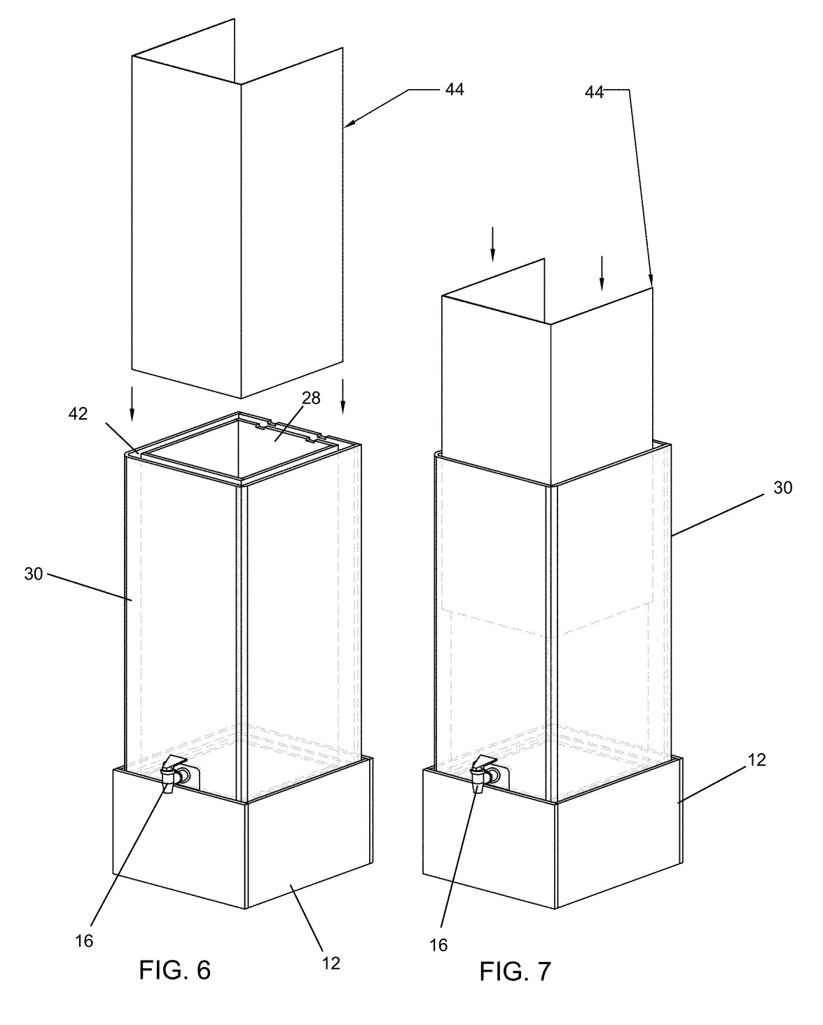

In the particular embodiment illustrated, container 28 and member 30 are substantially clear at least at the front and left and right side faces. Referring to FIGS. 6 and 7, perspective views of the infused beverage dispenser, the gap 42 provides a receiving space for insertion of a display insert member 44, which suitably has graphics thereon that can be used to convey to the consumer information about the beverage provided in the container 28. The particular insert member is a 3 sided flat sheet, formed or folded so as to fit within the gap 42 and provide coverage of each of 3 sides of the dispenser.

The insert in FIG. 6, is lowered into the space defined by the gap as shown in FIG. 7, until fully received in the space between the outer member 30 and inner container 28, the bottom edge of the insert resting on indexing lip 29, to define the extent to which the graphic lowers into the gap. The insert member 44 has dimensions corresponding to the height and width of the container 28/outer member 30, so it fits in the space. Since the walls of the outer member 30 are substantially clear, the graphic can be seen by consumers and the information, such as an indication of the flavor of infused water that is in the container 28, is easily perceived.

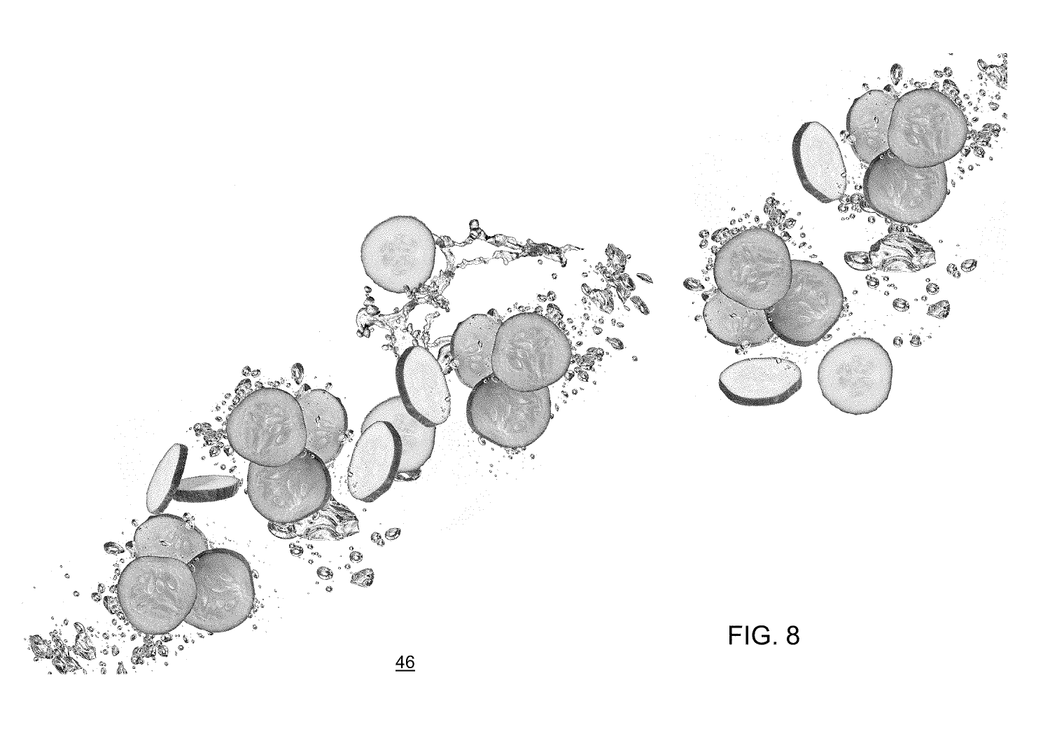

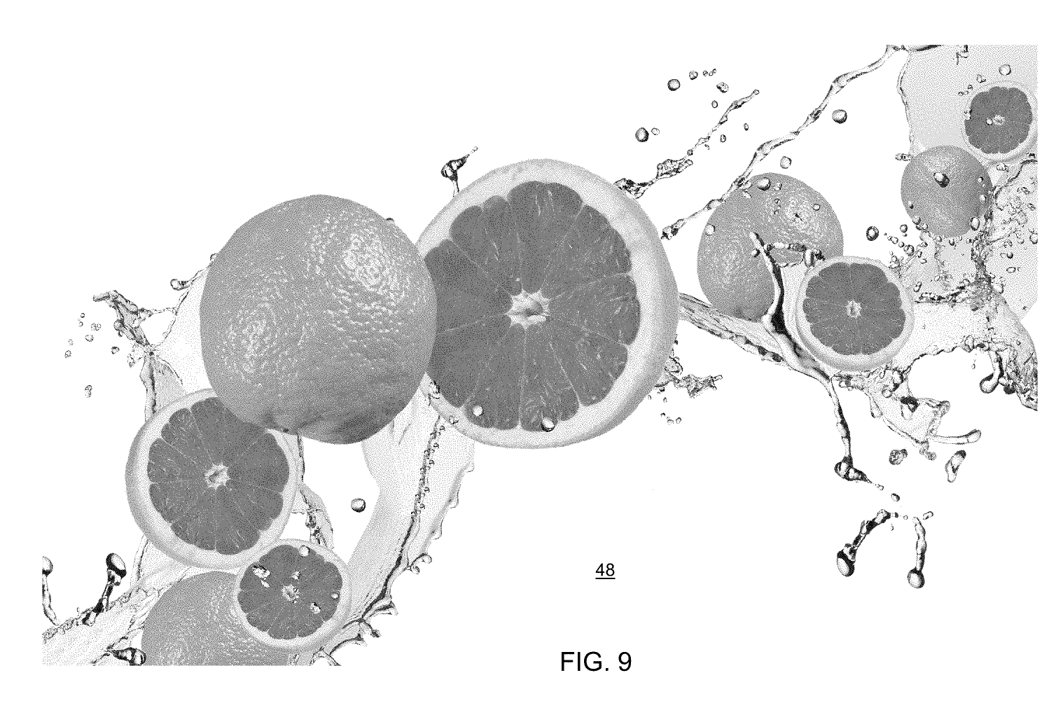

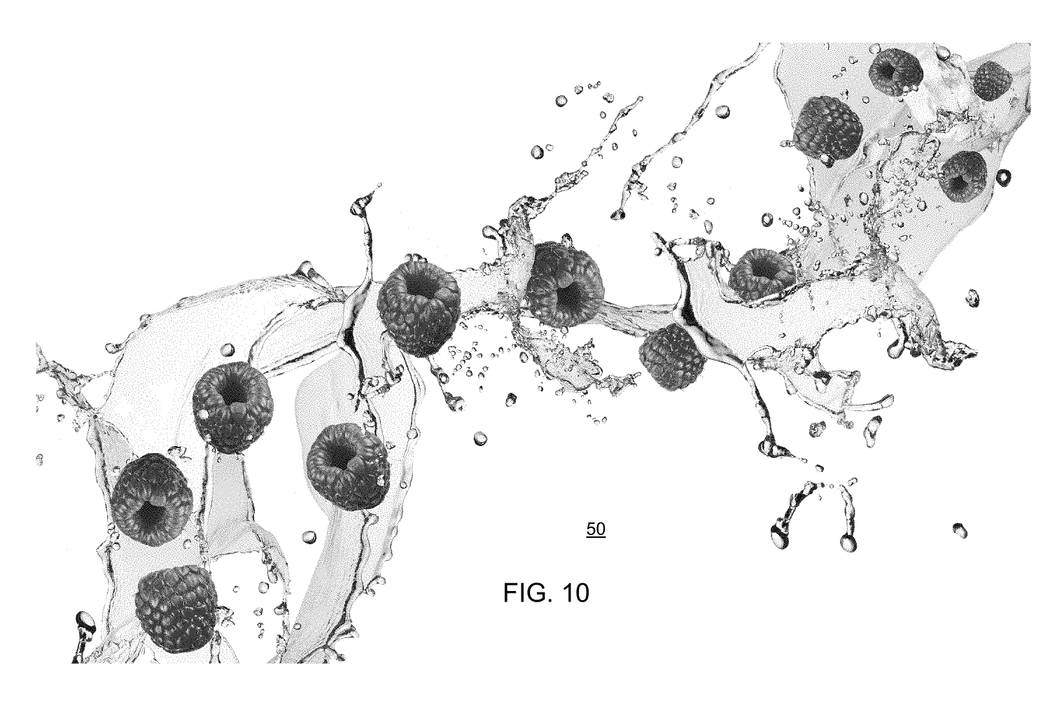

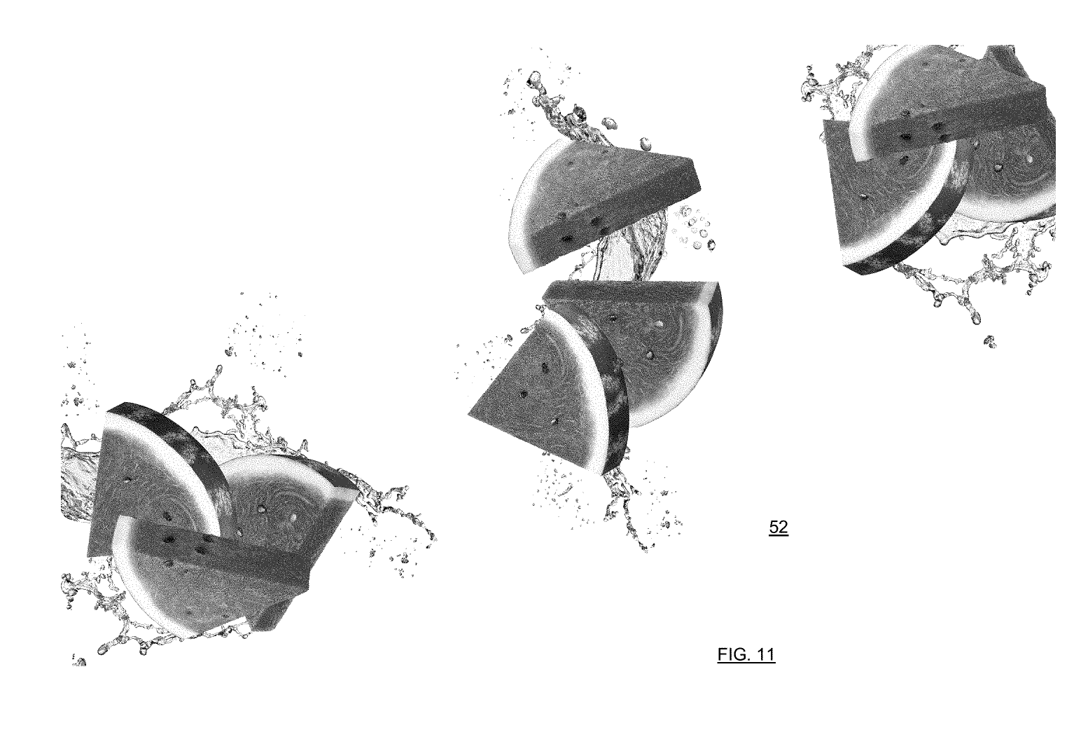

In particular embodiments, the information provided on the member 44 is in the form of pleasing graphical displays that represent the flavors of infused water that is in container 28. FIGS. 8-11 are views of exemplary graphic inserts 44 for a variety of infusion flavors, such as cucumber 46 (FIG. 8), grapefruit 48 (FIG. 9), raspberry 50 (FIG. 10) and watermelon 52 (FIG. 11). For the illustrated versions, the member 44 is substantially clear, so that only the graphics are visible when inserted to the beverage dispenser, and otherwise, the liquid inside the container 28 can be seen through the graphics. These particular items are shown for example purposes, and a wide variety of text and graphics can be employed depending on the use and type of beverage being dispensed. Typically the graphics will be depicted in the natural color of the fruit, vegetable, spice or herb that is shown, or colors that emphasize or highlight the flavor components.

Referring to FIG. 12, a rear view of the inner container 28 of the infused beverage dispenser, measurement marks 54 can be provided on the back wall, to assist in using the dispenser. The back wall may be frosted or opaque. In use, for the case of using the dispenser with flavor infused water, the lid 20 is removed, container 28 will be filled to a desired level with water, and the corresponding amount of flavor infusion concentrate can be added based on the amount of water added (or the water and concentrate can be mixed before filling container 28). The appropriate graphic or display member 44 is then inserted into the opening between container 28 and member 30, and lid 20 is replaced. Infused water can then be dispensed by operation of the faucet 16, with air flow to the inner container being provided by vents 34, 36 and 38 so that water can be dispensed evenly and without negative pressure build up inside the container 28

In a particular embodiment, the lid, container 28, member 30 and based 12 are made of acrylic. As noted above, container 28 and member 30 may be substantially clear, while the base 12 and lid 20 are given an aesthetically pleasing color, such as black. Other materials are also suitable for the various components, such as glass, or other plastics or material that can provide a transparent or translucent effect for the beverage container portions. The base can be made of plastic, metal, glass or other materials.

While the illustrated embodiment employs a graphic that fits between an inner and outer wall, other ways to accomplish the aesthetic display of the type of beverage can be employed. The graphic display in the preferred embodiment encompasses 3 sides of the rectangular shaped dispenser, but an alternative graphic can cover only 1 or 2 sides or just part of a side. Other manners of applying the graphic can be used. For example, a removable lightly adhesive transparent graphic material can be applied to the outside of the beverage containing vessel (in which case only vessel 28 need be employed. The graphic can be removed and used over and over again, replaced with another graphic when the beverage flavor is changed. Still another embodiment can employ artificial fruits or other indicators of the flavor that made of, e.g., plastic, and that can be inserted into the liquid to emulate the flavor extract being added, in which case there is no need for a graphic at all.

In accordance with the disclosure, improved ways to provide infused beverages are provided.

While a preferred embodiment of the technology has been shown and described, it will be apparent to those skilled in the art that many changes and modifications may be made without departing from the broader aspects. The appended claims are therefore intended to cover all such changes and modifications as fall within the true spirit and scope of the technology.

1. A beverage dispenser comprising:
a beverage dispenser vessel; and
a graphical indicator of the type of beverage that dispenser vessel may contain.

2. The beverage dispenser according to claim 1, wherein the beverage dispenser includes a receiver for holding the graphic indicator.

3. The beverage dispenser according to claim 2, wherein the receiver comprises a space defined between an inner wall and an outer wall of the beverage dispenser vessel.

4. The beverage dispenser according to claim 3, wherein the graphic indicator comprises a sheet adapted to removably fit within the space defined between the inner wall and outer wall of the beverage dispenser vessel, with photo or drawing elements representing flavors.

5. The beverage dispenser according to claim 4, wherein a substrate of the graphic indicator and the walls of the beverage dispenser vessel are substantially clear, so that only the graphics are visible when inserted to the beverage dispenser, and the beverage may be seen.

6. The beverage dispenser according to claim 1, wherein the graphic indicator comprises a sheet member adapted to removably adhere to an outer face of the beverage dispenser vessel.

7. The beverage dispenser according to claim 1, wherein the graphic indicator comprises an indicator for placement in the beverage that shows the type of flavoring.

8. The beverage dispenser according to claim 7, wherein the indicator for placement in the beverage comprises fruit shaped and colored members.

9. The beverage dispenser according to claim 1, further comprising a base member supporting the beverage dispenser vessel.

10. A beverage dispenser for displaying and dispensing flavor infused beverages, comprising:
an inner beverage dispenser vessel for holding the flavor infused beverage therein;
an outer beverage dispenser vessel surrounding portions of the inner beverage dispenser vessel and defining a graphical indicator receiving space therebetween; and
a graphical indicator of the type of beverage that dispenser vessel may contain adapted to be removably received in the graphical indicator receiving space.

11. The beverage dispenser for displaying and dispensing flavor infused beverages according to claim 10, wherein the graphical indicator comprises a substantially clear substrate with graphic elements thereon representing a flavor profile.

12. The beverage dispenser for displaying and dispensing flavor infused beverages according to claim 11, wherein the graphic elements are selected from representations of fruit, vegetables, herbs, or spices.

13. The beverage dispenser according to claim 10, further comprising a base member supporting the inner and outer beverage dispenser vessels.

14. A method for dispensing flavor infused beverages, comprising:
providing a beverage dispenser vessel for holding the flavor infused beverage therein;
providing a changeable graphical indicator of the type of beverage that dispenser vessel may contain removably on the beverage dispenser vessel.

15. The method according to claim 14, wherein the graphical indicator comprises a substantially clear substrate with graphic elements thereon representing a flavor profile.

16. The method according to claim 15, wherein the graphic elements are selected from representations of fruit, vegetables, herbs, or spices.

17. The method according to claim 14, further comprising providing a base member supporting the beverage dispenser vessel.
